(19) United States
(12) Patent Application Publication
(10) Pub. No.: US 2025/0054244 A1
(43) Pub. Date: Feb. 13, 2025

(54) Application Programming Interface for Discovering Proximate Spatial Entities in an Artificial Reality Environment

(71) Applicant: Meta Platforms Technologies, LLC, Menlo Park, CA (US)

(72) Inventors: Laura ONU, Kirkland, WA (US); Lionel Laurent REYERO, Lexington, MA (US); Nicki Zippora DLUGASH, Takoma Park, MD (US)

(21) Appl. No.: 18/448,439

(22) Filed: Aug. 11, 2023

(51) Int. Cl. G06T 19/00; G06T 7/73; G06V 20/20

(52) U.S. Cl. CPC G06T 19/006; G06T 7/73; G06V 20/20

(57) ABSTRACT

Implementations of the present technology can provide artificial reality (XR) applications with the ability to expand spatially outside of a single room, such that users of XR devices can navigate through their full living space and beyond. Through an application programming interface, XR applications can query the XR system for spatial entities (e.g., spatial anchors, scene elements, etc.) proximate to the user as the user moves around the living space, allowing the XR application to access not just the spatial entities created by the application. In some implementations, the system can identify the spatial entities within a threshold distance of the user and/or based on the room the user is in (after localizing the user) and apply a ranking to the identified entities. The system can then return a list of the identified spatial entities, the geometry of the entities, and the semantic label for the entities.

### TECHNICAL FIELD

The present disclosure is directed to providing an application programming interface (API) through which artificial reality (XR) applications can request spatial entities, proximate to a user of an XR device, that can be used to render an XR environment.

### BACKGROUND

Artificial reality (XR) devices are becoming more prevalent. As they become more popular, the applications implemented on such devices are becoming more sophisticated. Mixed reality (MR) and augmented reality (AR) applications can provide interactive 3D experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. An MR systems can have a pass-through display, which allows light from the real-world to pass through a lens to combine with light from a waveguide that simultaneously emits light from a projector in the MR system, allowing the MR system to present virtual objects intermixed with real objects the user can actually see. AR, MR, and VR (together XR) experiences can be observed by a user through a head-mounted display (HMD), such as glasses or a headset.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for discovering multiple spatial entities, proximate to a user in a real-world environment, for rendering an artificial reality environment.

FIG. 6A is a conceptual diagram illustrating an example view of a real-world environment having selected and unselected spatial entities overlaid thereon based on a room filter applied inside a closed room.

FIG. 6B is a conceptual diagram illustrating an example view of a real-world environment having selected and unselected spatial entities overlaid thereon based on a room filter applied in a partially enclosed room.

FIG. 6C is a conceptual diagram illustrating an example view of a real-world environment having selected and unselected spatial entities overlaid thereon based on a distance filter applied inside a room.

FIG. 6D is a conceptual diagram illustrating an example view of a real-world environment having selected and unselected spatial entities overlaid thereon based on a distance filter applied outside of a room,

FIG. 6E is a conceptual diagram illustrating an example view of a real-world environment having selected and unselected spatial entities overlaid thereon based on room and distance filters applied to a room in which walls are not found.

FIG. 6F is a conceptual diagram illustrating an example view of a real-world environment having selected and unselected spatial entities overlaid thereon based on room and distance filters applied to a room having walls longer than a threshold.

FIG. 7 is a conceptual diagram illustrating an example real-world environment having captured and received spatial entities overlaid thereon.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to providing artificial reality (XR) applications with the ability to expand spatially outside of a single room, such that users of XR devices can navigate through their full living space and beyond. Traditionally, XR applications are built to function on the scale of one room and must know specifically which spatial anchors they want to access (e.g., only spatial anchors that the XR application created itself). Through an application programming interface (API), XR applications can query a spatial entity discovery system for spatial entities (e.g., spatial anchors, scene elements, guardians, etc.) proximate to the user as the user moves around the living space, allowing the XR application to access not just the spatial entities it created. In some implementations, the spatial entity discovery system can identify the spatial entities within a threshold distance of the user (after localizing the user) and apply a ranking to the identified entities (e.g., based on which XR application is making the call, the relevance to the user, distance from the user, etc.). In some implementations, the spatial entity discovery system can identify the spatial entities based on the room the user is in, which, if not explicitly labeled, can be identified through computer vision techniques. The spatial entity discovery system can then return a list of the identified spatial entities, the geometry of the spatial entities (e.g., point, plane, cube, mesh, etc.), and the semantic label for the spatial entities (e.g., wall, table, chair, etc.).

For example, an XR home application, executing on an XR device, can request spatial entities (e.g., spatial anchors, scene element, guardians, etc.) established for a real-world environment surrounding a user via an application programming interface (API). In some implementations, responsive to receiving the request, the XR device can capture and upload feature points and/or visual features of the real-world environment to a remote computing system on a cloud. The remote computing system can use the provided feature points and/or visual features to determine the position of the XR device in one or more preexisting localization maps that have been uploaded and stored on the cloud. Once the position of the XR device is found, the remote computing system can then retrieve the spatial entities associated with that localization map. The remote computing system can return to the XR device: the position of the XR device in the one or more localization maps, the discovered spatial entities, and the positions of the discovered spatial entities in the one or more localization maps. The XR device can then locally track these spatial entities, and return them to the XR application as a response to the request. In some implementations, the XR device can further locally download the one or more localization maps in which the position of the XR device was found, such that the XR device can improve its own tracking. Although described above as being localized by a remote computing system, it is contemplated that the XR device can similarly localize itself on a locally stored localization map and obtain local- or cloud-stored spatial entities based on its determined position.

The cloud system or XR device can rank the spatial entities based on, for example, their distance from the XR device position, e.g., the closest spatial entity is ranked first, while the further spatial entity is ranked last, in descending order based on distance. The XR device, via the API, can provide the ranked spatial entities to the XR application. The XR application can then cause the XR device to render virtual objects that are part of the XR home experience based on the ranking of the spatial entities. For example, the XR device can render a virtual checkerboard on a physical table close to the user with a higher brightness level, higher refresh rate, larger sized, etc. based on highly ranked scene data for the table, relative to a lower brightness level, lower refresh rate, blurred, smaller sized, etc. virtual plant located at a spatial anchor further from the user.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the field of artificial reality. Traditionally, XR applications can only use spatial entities that it itself established. The technology improves upon this conventional approach by providing XR applications with spatial entities not known, not established, and/or otherwise previously inaccessible by them. Some implementations can establish system-level spatial entities and/or can aggregate spatial entities established by multiple different XR applications, such that the spatial entities can be used and persist across multiple different XR applications and experiences. By not storing the list of spatial entities in the XR application, some implementations can allow XR experiences to be built across an expanded scale. For example, an XR device can be used across a whole campus, city, or world in which spatial anchors and their associated content can be discovered.

Further, by ranking the spatial entities provided to the XR application, the XR application can selectively render virtual objects relative to these spatial entities, and/or apply different rendering rules to such virtual objects. Some implementations can base such a ranking on relevance to the user and/or the executing XR application to create a customized user experience. Alternatively or additionally, some implementations can base the ranking on distance from the XR device, allowing the XR device to use fewer display and processing resources to render virtual objects positioned further from the user, as they can be deemed less important.

In addition, some implementations can store some spatial entities locally on the XR device, while storing others on a platform computing system on a cloud. After obtaining spatial entities proximate to the user from the cloud, the XR device can render an XR experience using the spatial entities, without having to itself capture and persistently store all of the spatial entities needed to render the XR experience. Thus, some implementations can conserve storage space on an XR device. Further, by storing unnecessary, infrequently used, and/or physically distant spatial entities on a cloud, the XR device can locally store larger amounts of data needed to execute an XR application and render an XR experience, improving latency and processing speed on the XR device.

Further, some implementations can identify and obtain scene elements as spatial entities either from a platform computing system on a cloud or from another XR device. The XR device can then render virtual objects with respect to physical objects indicated by the scene data (e.g., as an augmented reality (AR) or mixed reality (MR) experience), without the XR device having to rescan the scene for the physical objects itself. Thus, some implementations described herein can result in time savings, improved efficiency, and lower processing requirements for the XR device.

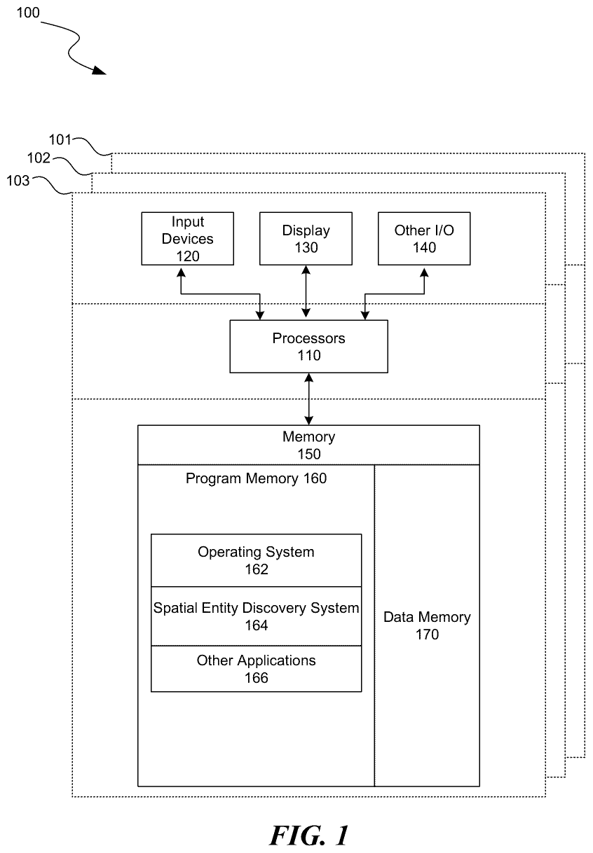

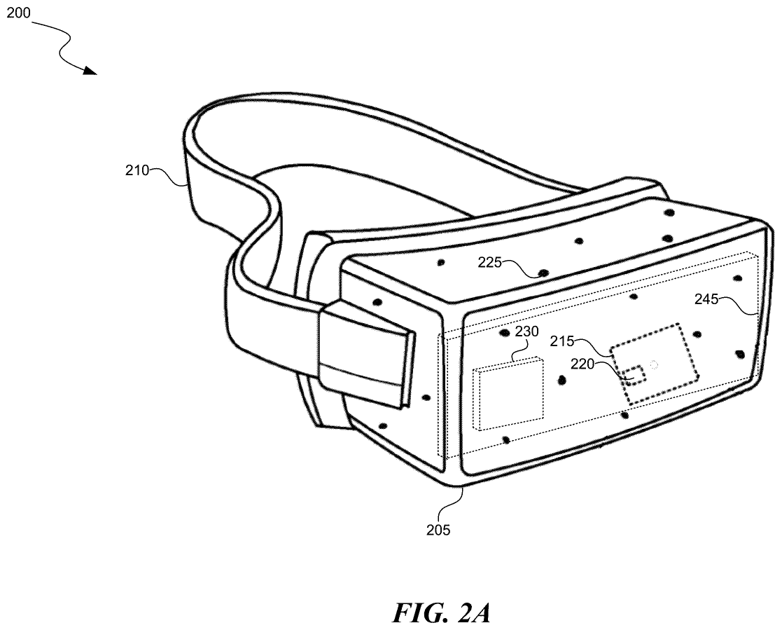

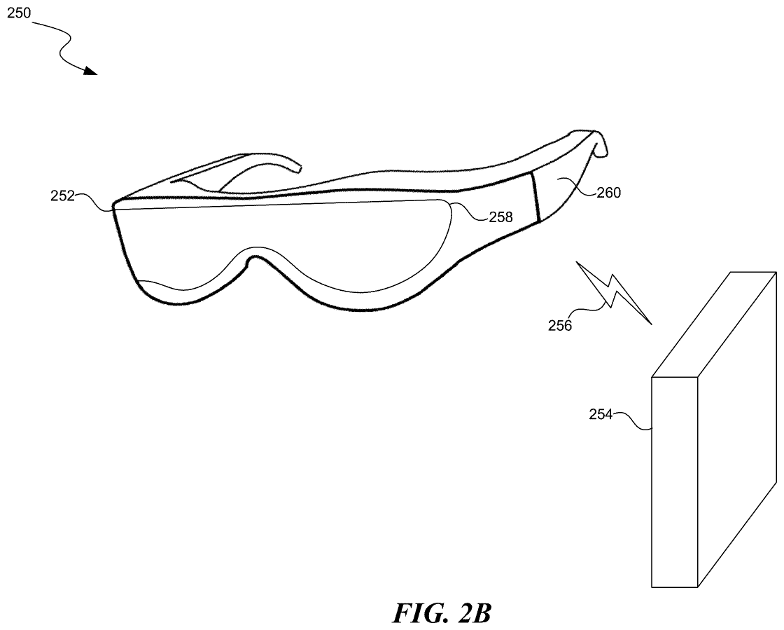

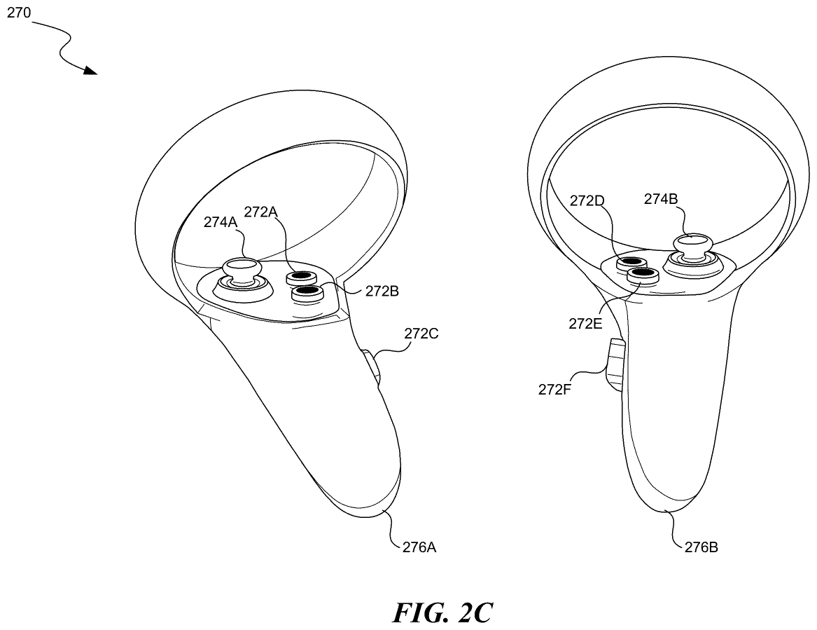

Several implementations are discussed below in more detail in reference to the figures. FIG. 1 is a block diagram illustrating an overview of devices on which some implementations of the disclosed technology can operate. The devices can comprise hardware components of a computing system 100 that can discover spatial entities, proximate to a user in a real-world environment, for rendering an artificial reality (XR) environment. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, spatial entity discovery system 164, and other application programs 166. Memory 150 can also include data memory 170 that can include, e.g., XR device data, localization data, XR application data, spatial entity data, physical space data, ranking data, rendering data, application programming interface (API) data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3DoF) or six degrees of freedom (6DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

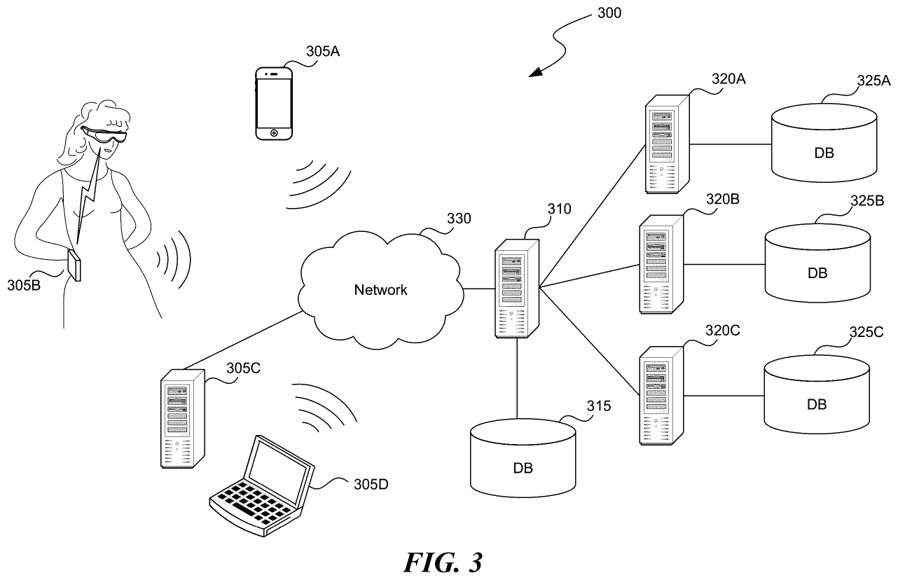

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

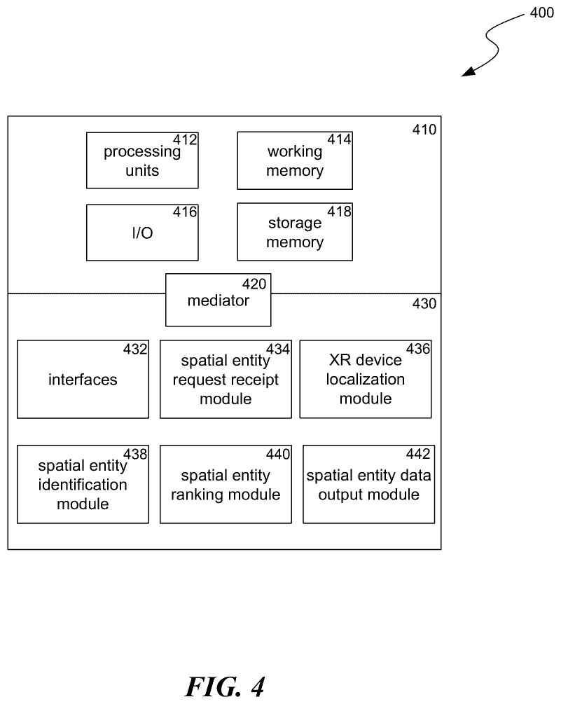

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

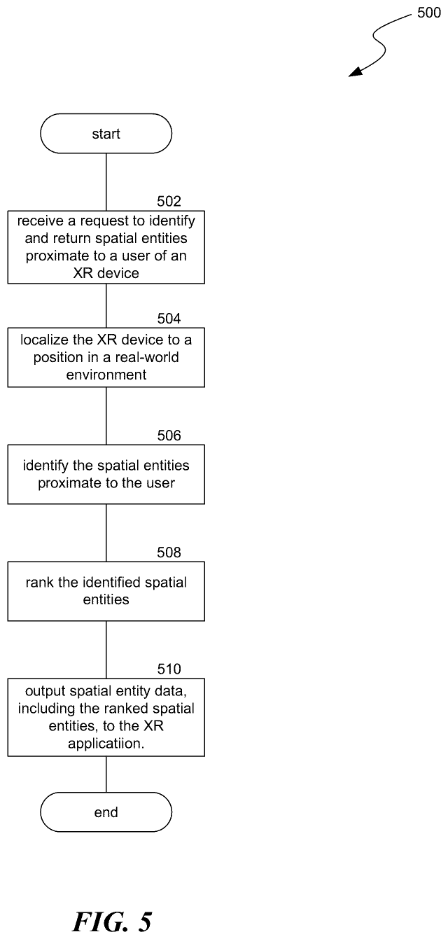

Specialized components 430 can include software or hardware configured to perform operations for discovering spatial entities, proximate to a user in a real-world environment, for rendering an artificial reality (XR) environment. Specialized components 430 can include spatial entity request receipt module 434, artificial reality (XR) device localization module 436, spatial entity identification module 438, spatial entity ranking module 440, spatial entity data output module 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications. In some implementations, specialized components 430 can execute process 500 of FIG. 5. In some implementations, specialized components 430 can be included in spatial entity discovery system 164 of FIG. 1.

Spatial entity request receipt module 434 can receive, from an XR application executing on an XR device, a request to select and return spatial entities proximate to a user of the XR device, the XR device being used by the user in a real-world environment. Spatial entity request receipt module 434 can receive the request via a call made by the XR application to an application programming interface (API) on the XR device. In some implementations, the XR application can have access to some spatial entities that it captured or obtained, but could need additional spatial entities in order to render an XR experience, thereby generating the request. In other words, the XR application can request one or more spatial entities that are otherwise unknown to and/or not created by the XR application. In some implementations, spatial entity request receipt module 434 can receive the request for one or more particular types of spatial entities proximate to the user (e.g., spatial anchors, scene elements, guardians, and/or three-dimensional (3D) meshes corresponding to the real-world environment), such as based on what is needed by the XR application to render content, and/or based on what is unavailable to the XR application. In some implementations, however, spatial entity request receipt module 434 can receive the request for all spatial entities proximate to the user. Further details regarding receiving a request to identify and return spatial anchors proximate to a user of an XR device are described herein with respect to block 502 of FIG. 5.

XR device localization module 436 can localize the XR device to a position in the real-world environment. In some implementations, XR device localization module 436 can determine the position and/or orientation of the XR device in the real-world environment based on visual features (e.g., furniture, decorations, etc.) of the real-world environment captured by one or more cameras on the XR device in real-time. In such implementations, XR device localization module 436 can compare the visual features to one or more previously captured images of the real-world environment, e.g., by extracting relevant features from the current images and comparing them to identified features of the preexisting images through object recognition, in order to ascertain the position and/or orientation of the XR device in the real-world environment. In some implementations, in addition to analyzing visual features of the real-world environment, XR device localization module 436 can use depth sensors to capture depth data indicative of the XR device's depth relative to the visual features identified in the real-world environment.

In some cases, the localization process can determine the position and/or orientation of the XR device using Simultaneous Localization and Mapping (SLAM) techniques. For example, the XR device can capture and/or obtain visual features or feature points surrounding the XR device in the real-world environment. XR device localization module 436 can align the visual features or feature points with one or more preexisting localization maps established for the real-world environment (stored locally on the XR device, stored on another XR device, and/or stored on a cloud). Once the captured visual features or feature points are aligned with the preexisting localization maps for the real-world environment, XR device localization module 436 can determine the position of the XR device in the real-world environment relative to a set of preexisting localization maps for the real-world environment. Further details regarding localizing an XR device to a position in a real-world environment are described herein with respect to block 504 of FIG. 5.

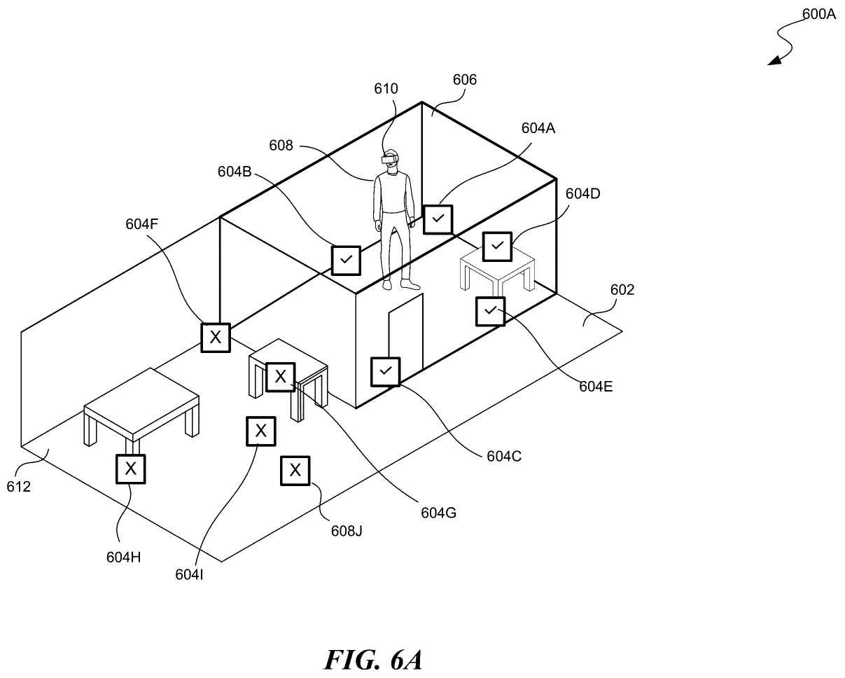

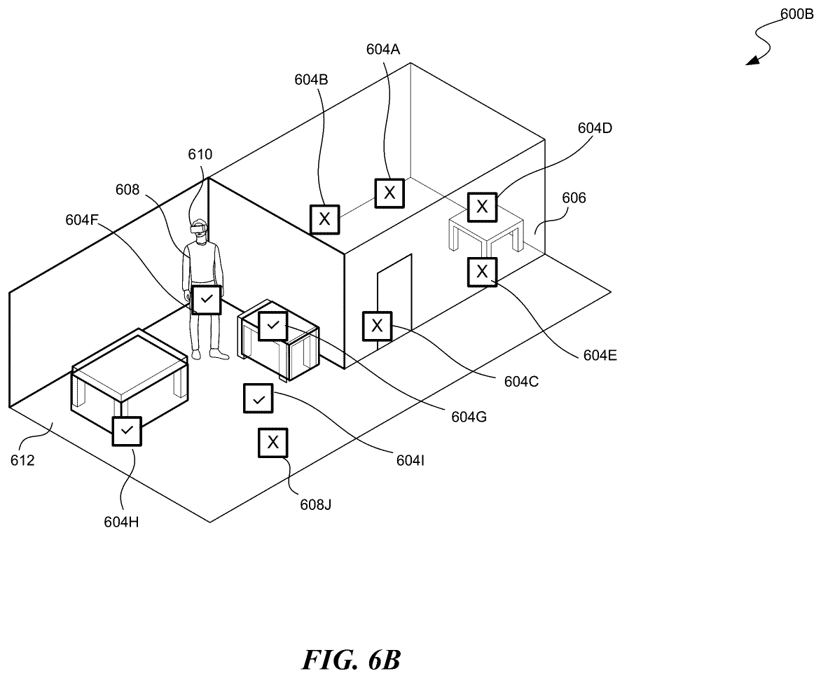

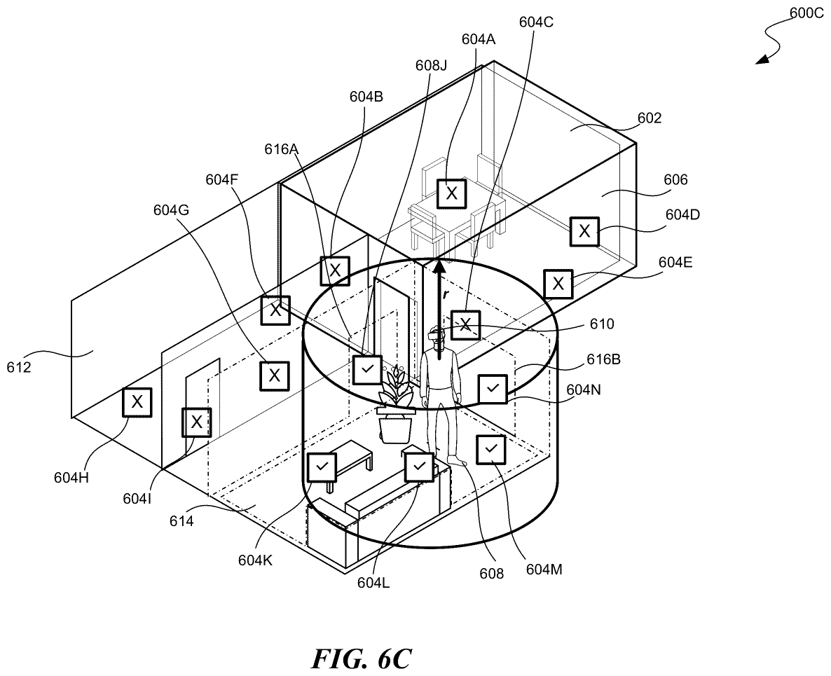

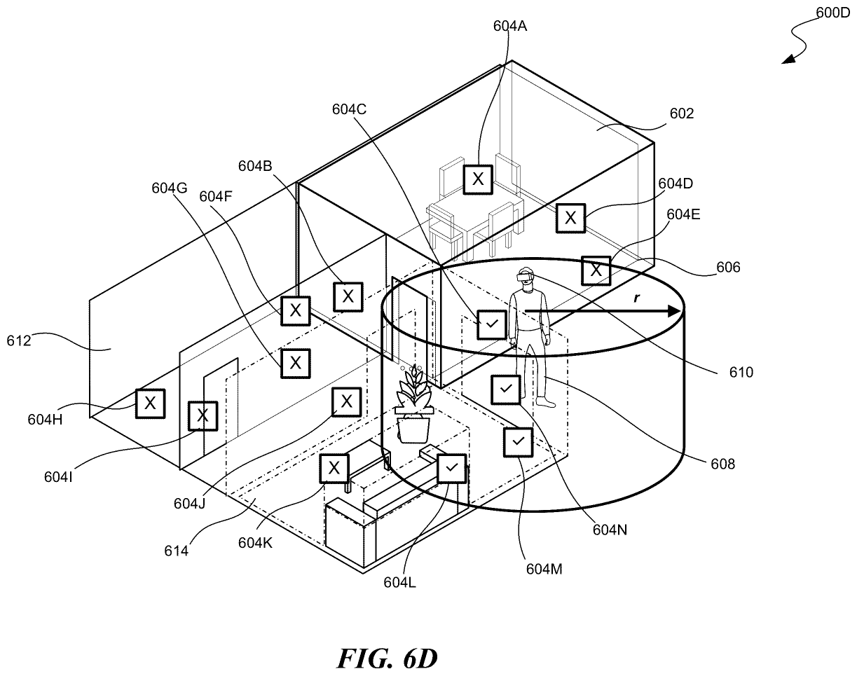

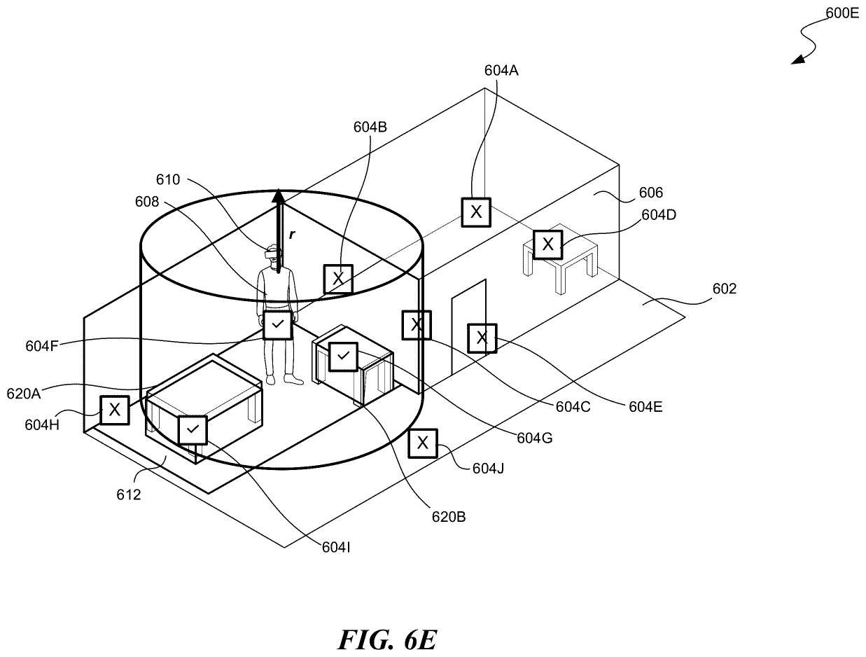

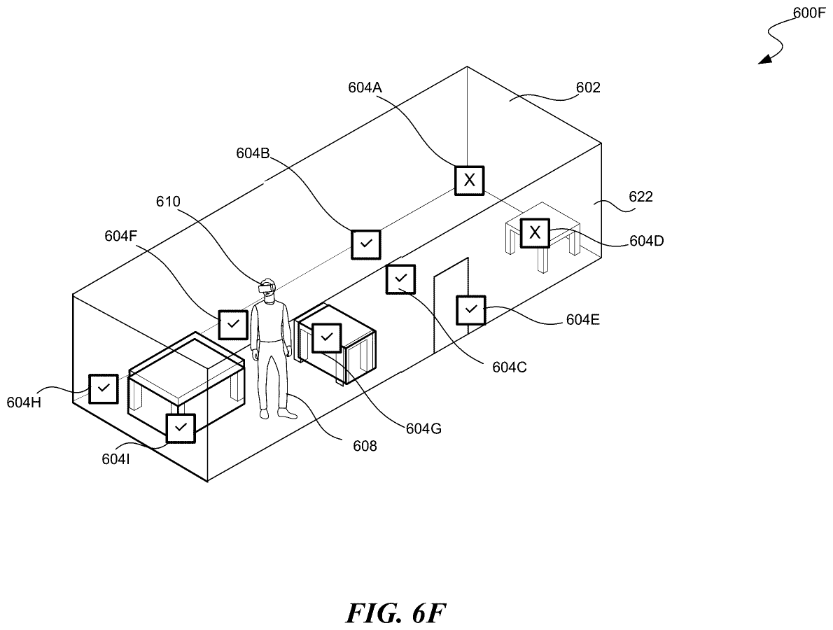

Spatial entity identification module 438 can identify and select spatial entities proximate to the user based on one or more filters. The filters can include a distance filter, a room filter, or a combination thereof. To apply a distance filter, spatial entity identification module 438 can identify and select one or more spatial entities within a threshold distance (e.g., three meters) of the position of the XR device in the real-world environment, as determined by XR device localization module 436, such as in one or more of the preexisting localization maps. Examples of applying a distance filter are shown and described herein with respect to FIGS. 6C and 6D.

To apply a room filter, spatial entity identification module 438 can identify and select one or more spatial entities within a physical space surrounding the position of the XR device in the real-world environment. In some implementations, the delineated physical space can be a room. In some implementations, spatial entity identification module 438 can identify the spatial anchors within the physical space by delineating the physical space. Examples of applying a room filter are shown and described herein with respect to FIGS. 6A and 6B. Examples of applying composite room and distance filters are shown and described herein with respect to FIGS. 6E and 6F.

In some implementations, spatial entity identification module 438 can delineate the physical space by capturing, obtaining, or otherwise establishing or accessing an XR physical space model (e.g., a “room box,” as referenced interchangeably herein) for the real-world environment that can be adjusted by the user to indicate where the walls, floor, and and/or ceiling exist. Spatial entity identification module 438 can obtain the room box by capturing the physical space, e.g., using one or more cameras and/or one or more depth sensors in input/output devices 416, which may be presented to the user for verification and/or modification. In some implementations, spatial entity identification module 438 can capture the XR physical space model automatically, e.g., by automatically identifying the physical walls, floor, and/or ceiling using object recognition techniques, by analyzing color and/or depth data to identify continuous planes, etc. In some implementations, spatial entity identification module 438 can prompt a user to manually capture the XR physical space model, e.g., by placing a controller (e.g., controller 276A and/or controller 276B of FIG. 2C) on the floor, by outlining the walls and/or ceiling, etc. In some implementations, spatial entity identification module 438 can obtain a previously captured XR physical space model corresponding to the real-world space, such as from local storage, another XR device, or from a cloud. Further details regarding capturing a realigning an XR physical space model are described in U.S. patent application Ser. No. 18/346,379, filed Jul. 3, 2023, entitled “Artificial Reality Room Capture Realignment” (Attorney Docket No. 3589-0262US01), which is herein incorporated by reference in its entirety.

In some implementations, spatial entity identification module 438 can delineate the physical space by generating a three-dimensional (3D) mesh of the physical space. For example, spatial entity identification module 438 can scan the physical space (including physical objects) and display a mesh corresponding to the scanned area while the user looks and moves around. In some implementations, spatial entity identification module 438 can use a room box (if obtained) to refine the mesh. For example, spatial entity identification module 438 can use the room box to refine the mesh in multiple ways: A) using the room box as ground truth for large, flat spaces (e.g., collapsing minor variations in the mesh identified in the walls, ceiling, and/or floor onto the room box; and clipping the mesh to the room box where windows, open doorways, etc. result in the mesh extending beyond the walls); B) using the identified walls, ceiling, and/or floor of the room box to simplify the triangles representing the scanned area, resulting in fewer processing resources being used to generate, and later use, the mesh; and C) identifying whether a threshold percentage of the room box is covered by the mesh to determine whether the mesh of the physical space is sufficiently complete. In some implementations, spatial entity identification module 438 can obtain a previously captured 3D mesh corresponding to the real-world space, such as from local storage, another XR device, or from a cloud. Once the physical space is delineated, spatial entity identification module 438 can identify and select spatial entities within that physical space. Further details regarding identifying spatial entities proximate to a user of an XR device are described herein with respect to block 506 of FIG. 5.

Spatial entity ranking module 440 can rank the spatial entities identified by spatial entity identification module 438. Spatial entity ranking module 440 can rank the spatial entities based on any of one or more criteria or any combination thereof. In some implementations, spatial entity ranking module 440 can rank the spatial entities based on their distances from the position of the XR device in the real-world environment, as determined by XR device localization module 436. For example, spatial entity ranking module 440 can rank the spatial entity closest to the XR device highest, descending in order down to the furthest spatial entity. In some implementations, spatial entity ranking module 440 can rank the spatial entities based on their relevance to the XR application, e.g., spatial entities being more likely to be used by the XR application and/or based on the type of XR application (e.g., an XR bowling application as compared to an XR chat application). In some implementations, spatial entity ranking module 440 can rank the spatial entities based on their relevance to the user of the XR device, e.g., attributes or demographic data of the user indicative of particular spatial entities and/or XR experiences that are likely to be used, activities likely to be performed, movement data of the user (e.g., whether the user is stagnant or moving about the real-world environment, etc.). In some implementations, spatial entity ranking module 440 can rank the spatial entities according to a confidence value indicative of whether a spatial entity's position and/or orientation as identified is correct. Further details regarding ranking spatial entities are described herein with respect to block 508 of FIG. 5.

Spatial entity data output module 442 can output spatial entity data, including the ranked spatial entities, to the requesting XR application. Using one or more of the ranked spatial entities, the XR application can cause the XR device to render an XR environment based, at least partially, on the ranked multiple spatial entities. For example, the XR application can provide instructions to the XR device to render virtual objects relative to spatial entities, and in some implementations, based on their ranking. For example, the XR application can provide instructions to render virtual objects ranked higher at a brightness level corresponding to the ranking of their corresponding spatial entities, at particular sizes relative to the ranking of their corresponding spatial entities, to render no virtual objects corresponding to lower ranked spatial entities, etc. Further details regarding outputting spatial entity data to an XR application are described herein with respect to block 510 of FIG. 5.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations of the present technology for discovering multiple spatial entities, proximate to a user in a real-world environment, for rendering an artificial reality (XR) environment. In some implementations, process 500 can be performed upon receipt of a request, from an XR application via an application programming interface (API), to identify and return the spatial entities proximate to the user. In some implementations, XR application, requiring spatial entities for rendering the XR environment, can automatically generate the request upon execution. In some implementations, process 500 can prompt the XR application to request the spatial entities.

In some implementations, process 500 can be partially or fully performed by one or more XR devices in an XR system, such as an XR HMD (e.g., XR HMD 200 of FIG. 2A and/or XR HMD 252 of FIG. 2B), one or more external processing components, etc. In some implementations, process 500 can be partially or fully performed by a platform computing system located remotely from the one or more XR devices, such as on a cloud over a network (e.g., network 330 of FIG. 3). In some implementations, process 500 can be performed by spatial entity discovery system 164 of FIG. 1.

At block 502, process 500 can receive, from an XR application executing on an XR device, a request to identify and return spatial entities proximate to the user of the XR device. In some implementations, process 500 can receive the request via an API allowing for discovery of spatial entities established for a real-world environment. In some implementations, the API can allow for the discovery of at least one spatial entity that was not established by the XR application and/or is otherwise unknown or unavailable to the XR application. In some implementations, process 500 can receive a request from the XR application for one or more particular types of spatial entities, such as spatial anchors, scene data, guardians, three-dimensional (3D) meshes, etc. In some implementations, the request can include one or more specifications for the spatial entities, e.g., spatial entities created by a particular XR application (either itself or a different XR application), spatial entities having a particular geometry (e.g., point, plane, volume, or mesh), spatial entities having a specific semantic label (e.g., table, wall, ceiling, etc.), and/or the like. However, in some implementations, process 500 can receive a request from the XR application for all spatial entities proximate to the user.

In some implementations, the spatial entities can include one or more spatial anchors (stored in the form of spatial anchor data). Spatial anchors can be world-locked frames of reference that can be created at particular positions and orientations to position virtual content at consistent points in an XR experience. In some implementations, spatial anchors can be persistent across different sessions of an XR experience, such that a user can stop and resume an XR experience, while still maintaining content at the same locations in the real-world environment. In some implementations, the spatial anchors can have geometry (e.g., points, planes, etc.). In some implementations, the spatial anchors for the real-world environment can be created by the same or a different XR device than that performing process 500.

In some implementations, the spatial entities can include one or more scene elements (stored in the form of scene data). The scene elements can be initially obtained by scanning the real-world environment to specify object locations and types within a defined scene lexicon or semantic label (e.g., desk, chair, wall, floor, ceiling, doorway, etc.). In some implementations, the scene elements can further include geometry (e.g., shape of the scene elements), such as a collection of points, a cube, a sphere, etc., or combination of geometric shapes representative of an object (e.g., multiple planes and cuboids making up a table). The scene identification can be performed, e.g., through a user manually identifying a location with a corresponding object type or with a camera to capture images of physical objects in the scene, and using computer vision techniques to identify the physical objects as object types. In some implementations, the XR device performing the scanning can then store the object types in relation to one or more spatial anchors defined for that area. In some implementations, the XR device scanning the real-world area can be the same or different XR device than that creating the spatial anchors, and/or can be the same or different XR device than that performing process 500. Further details regarding capturing and/or sharing scene data are described in U.S. patent application Ser. No. 18/069,029, filed Dec. 20, 2022, entitled “Shared Scene Co-Location for Artificial Reality Devices” (Attorney Docket No. 3589-0205US01), which is herein incorporated by reference in its entirety.

In some implementations, the spatial entities can include one or more guardians corresponding to the real-world environment. In some implementations, the guardians can define safe spaces in which the user can move without colliding with real-world objects. In some implementations, the guardians can define spaces within which the XR application can render content. In some implementations, the guardians can delineate boundaries in particular physical spaces. For example, a guardian can correspond to a particular room within a real-world environment. In another example a guardian can correspond to a particular physical object within a real-world environment (e.g., a physical desk). In some implementations, the guardians can further include semantic labels (e.g., living room, kitchen, tabletop, countertop, etc.). In some implementations, the guardians can be generated manually (e.g., by a user outlining the boundary of a room by pointing or using a controller), while in some implementations, the guardians can be detected automatically (e.g., by using computer vision to identify walls), which can be corrected manually if needed.

In some implementations, the spatial entities can include one or more three-dimensional (3D) meshes corresponding to the real-world environment and/or one or more delineated physical spaces within the real-world environment. The 3D meshes can initially be obtained using cameras and depth sensors integrated in an XR device to scan the world surrounding a user, in order to generate a 3D model of the world using computer vision. For example, using the 3D mesh, the XR application can display a virtual ball bouncing off not only the walls and floor, but also objects in the real-world environment of the user. In some implementations, the XR device generating the 3D mesh can be the same or different XR device than that creating the spatial anchors, the same or different XR device capturing the scene data, and/or the same or different XR device than that performing process 500.

At block 504, process 500 can localize the XR device to a position in the real-world environment. In some implementations, process 500 can localize the XR device to the position in the real-world environment on one or more localization maps, e.g., Simultaneous Localization and Mapping (SLAM) maps. For example, process 500 can capture, with the XR device, a current localization map including one or more spatial anchors of the real-world environment, the spatial anchors either being created by process 500 or being locally stored and/or cached on the XR device. The spatial anchors can each be associated with a location in the real-world environment.

In some implementations, process 500 can localize the user by comparing the newly captured localization map, including the spatial anchors, to one or more locally stored and previously captured localization maps for the real-world environment. In some implementations, however, process 500 can upload the captured localization map including the spatial anchors to a platform computing system having access to a database of spatial anchors across multiple locations in multiple real-world environments. Process 500 (or the platform computing system) can merge the newly captured localization map with the preexisting localization map by aligning, in the preexisting localization map, the locations in the real-world environment corresponding to the obtained spatial anchors with the locations of preexisting spatial anchors. Thus, process 500 (or the platform computing system) can determine, within the preexisting localization map, a location of the XR device (e.g., through triangulation or similar methods).

Alternatively or additionally, process 500 {or the platform computing system) can determine the location of the XR device based on one or more visual features in the real-world environment (e.g., identified objects corresponding to images of previously captured objects). In some implementations, process 500 (or the platform computing system) can correspond the visual features to the obtained spatial anchors in order to find the location of the XR device, in conjunction with the captured localization map. In some implementations, process 500 can further use depth data (e.g., captured by one or more depth sensors) to determine the distance of the XR device from one or more physical objects captured by the XR device.

At block 506, process 500 can identify the spatial entities proximate to the user. In some implementations, the spatial entities proximate to the user can include one or more spatial entities within a threshold distance (e.g., 2 meters) of the position of the XR device in the real-world environment. In other words, process 500 can apply a distance filter to all available spatial entities for the real-world environment to eliminate those spatial anchors outside the threshold distance from those provided to the XR application. Examples of applying distance filters to available spatial entities for a real-world environment are shown and described herein relative to FIGS. 6C and 6D.

In some implementations, the spatial entities proximate to the user can include one or more spatial entities within a delineated physical space surrounding the position of the XR device in the real-world environment. In some implementations, the delineated physical space can be a fully or partially enclosed room. In some implementations, however, the delineated physical space can be outside of a fully or partially enclosed room (e.g., outside a house). In some implementations, process 500 can identify the delineated physical space by applying computer vision techniques to identify walls surrounding the XR device in the real-world environment. Examples of applying room filters to available spatial entities for a real-world environment are shown and described herein relative to FIGS. 6A and 6B. In some implementations, process 500 can identify the spatial entities proximate to the user by applying both a distance filter and a room filter, as shown and described relative to FIGS. 6E and 6F. When the request received from the XR application includes one or more specifications (e.g., spatial entities created by a particular XR application, having particular geometry, having a particular semantic label, etc.), process 500 can filter the spatial entities proximate to the user based on these requirements in some implementations.

In some implementations, process 500 can identify the spatial entities from multiple SLAM maps established for the real-world environment. As described further herein, in some implementations, the SLAM maps can be stored locally on the XR device. In some implementations, however, the SLAM maps can be stored on a cloud, e.g., on a platform computing system. In some implementations, one or more SLAM maps can be stored locally on the XR device, while one or more SLAM maps can be stored on the cloud.

Once identified and filtered, process 500 can obtain the spatial entities. In some implementations, the spatial entity data (including, e.g., an identification of the spatial entity, geometry data, semantic label data, position data, orientation data, etc.) can be stored locally on the XR device performing process 500. In some implementations, the spatial entity data can be stored on another XR device that accessed the real-world environment, and can be obtained by process 500 by establishing a communication link with the other XR device, (e.g., over network 330 of FIG. 3, which can, in some implementations, include local communication protocols, such as over WiFi, via near field communication (NFC), via Bluetooth or Bluetooth Low Energy (BLE), etc.).

In some implementations, process 500 can obtain the spatial entity data from a cloud, e.g., from a platform computing system over a network. Because the user can use the XR device in many different locations in the real-world environment (e.g., multiple rooms or physical spaces in a home, in an office, in other people's homes, etc.), a large number of spatial entities may need to be stored to consistently render content at those locations. However, due to the storage constraints on an XR device, some created spatial anchors, captured scene elements, and/or 3D meshes often cannot be retained locally. Thus, in some implementations, some or all of the spatial entity data can be stored on a cloud. In some implementations, process 500 can obtain the spatial entity data from any combination of local storage on the XR device, another XR device, and/or the cloud.

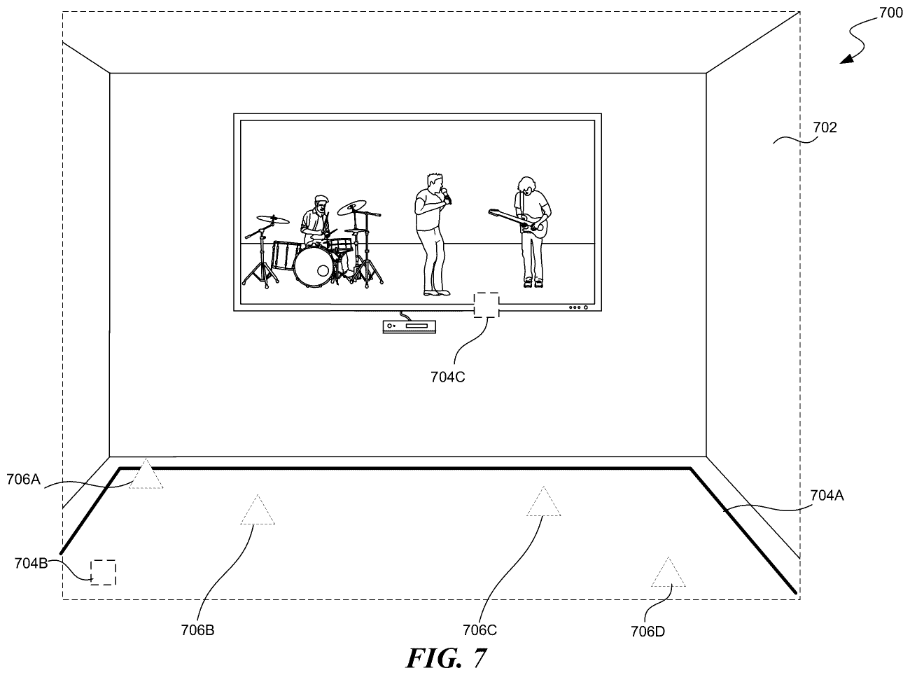

For example, some spatial entities can be stored locally on the XR device, while others can be stored on the platform computing system on the cloud. In some implementations, the XR device can create, capture, and/or access locally cached spatial anchors at locations in a real-world environment, then upload those spatial anchors to the platform computing system (e.g., based on user permissions). The platform computing system can align the uploaded spatial anchors on a localization map, query a database for preexisting spatial anchors for the real-world environment (e.g., that are proximate to the XR device), and transmit the preexisting spatial anchors back to the XR device. The XR device can then render the XR experience corresponding to the XR application using the uploaded spatial anchors and the preexisting spatial anchors (which may have corresponding scene data), without having to itself capture and persistently store all of the spatial anchors needed to render the XR experience. Further details regarding obtaining spatial entities from a cloud are described in U.S. patent application Ser. No. 18/068,918, filed Dec. 20, 2022, entitled “Coordinating Cloud and Local Spatial Anchors for an Artificial Reality Device” (Attorney Docket No. 3589-0202US01), which is herein incorporated by reference in its entirety. An exemplary real-world environment having locally captured and remotely received spatial entities overlaid thereon is shown and described with respect to FIG. 7.

At block 508, process 500 can rank the identified spatial entities. In some implementations, process 500 can rank the identified spatial entities based on distance from the position of the XR device in the real-world environment. For example, process 500 can rank the closest spatial entity to the position of the XR device the highest, down to the furthest spatial entity from the position of the XR device. In some implementations, process 500 can rank the identified spatial entities based on the spatial entities that are within the field-of-view of the XR device, e.g., based on the position and orientation of the XR device in the real-world environment. Thus, for example, process 500 can rank higher a spatial entity in a separate physical space, viewable through an open door, than a spatial entity behind the user of the XR device in the same room as the XR device. When the request received from the XR application includes one or more specifications (e.g., spatial entities created by a particular XR application, having particular geometry, having a particular semantic label, etc.), process 500 can rank the spatial entities according to these requirements in some implementations. For example, process 500 can rank spatial entities higher that meet the specifications and/or meet more of the specifications than other spatial entities that do not meet the specifications and/or meet less of the specifications.

In some implementations, process 500 can rank the identified spatial entities based on relevance to the XR application. For example, if the XR application is a workplace productivity application, process 500 can rank spatial entities near and/or corresponding to a desk in the real-world environment higher than those away from the desk or otherwise unrelated to working (e.g., scene data for a plant). In some implementations, process 500 can rank the identified spatial entities based on relevance to the user of the XR device, such as spatial entities that are frequently accessed and used by the user on the XR device, the most recent spatial entities accessed and used by the user on the XR type, the types of content typically rendered by the XR device of the user, habits of the user while using the XR device (e.g., moves around often, stays stagnant, etc.), and/or any other contextual factors relative to the user and/or the user's usage of the XR device. In some implementations, process 500 can rank the identified spatial entities based on any combination of these factors, and, in some implementations, apply weights to certain spatial entities and/or such factors to generate the ranking.

At block 510, process 500 can output spatial entity data, including the ranked spatial entities, to the XR application via the API. As discussed further above, the spatial entity data can further include geometry data and/or semantic labels for the spatial entities in some implementations. Once the spatial entity data is received, the XR application can cause the XR device to render the XR environment based, at least partially, on the spatial entities. For example, the XR application can cause the XR device to render virtual objects in the real-world environment relative to physical objects in the real-world environment, e.g., on a table, hanging on a wall, etc.

In some implementations, the XR application can cause the XR device to render virtual objects differently based on their ranking. For example, the XR device can render a virtual plant further from the XR device as faded relative to a virtual plant closer to the XR device. In another example, the XR device can render a virtual dog in an adjoining physical space, seen through an open doorway, darker than a virtual chess set in the physical space in which the XR device is located. Although illustrated as a single process 500, it is contemplated that process 500 can be performed repeatedly, either consecutively or concurrently, as the XR application continues to execute, as the user traverses the real-world environment (e.g., entering and leaving particular physical spaces), and/or “on demand” by the XR application as the XR application requests further spatial entities.

FIG. 6A is a conceptual diagram illustrating an example view 600A of a real-world environment 602 having selected and unselected spatial entities 604A-J overlaid thereon based on a room filter applied inside a closed room 606 (e.g., a delineated physical space). When user 608 is inside fully enclosed room 606 (e.g., within four walls with no open doorways, for example), the room filter in this example can filter available spatial entities to be limited to only spatial entities within the volume of the room 606, e.g., selected spatial entities 604A-E. Thus. spatial entities outside the volume of room 606, e.g., unselected spatial entities 604F-J, can be excluded from the set of spatial entities 604A-E provided to a requesting XR application. Some implementations can determine that the user 608 is in a fully enclosed room 606 by, for example, accessing guardian data for room 606 on XR device 610, using computer vision techniques on XR device 610 to identify walls and closed doorways, using a room box, using a generated three-dimensional (3D) mesh, etc.

FIG. 6B is a conceptual diagram illustrating an example view 600B of a real-world environment 602 having selected and unselected spatial entities 604A-J overlaid thereon based on a room filter applied inside a partially enclosed (or partially captured) room 612 (e.g., a delineated physical space). When room 612 does not have four walls (i.e., is not fully enclosed) and/or when XR device 610 does not capture or detect four walls, XR device 610 can infer that room 612 is rectangular with a cuboid volume. The room filter in this example can filter available spatial entities 604A-J within the inferred volume, e.g., selected spatial entities 604F-I. Thus, spatial entities outside the inferred volume of room 612, e.g., unselected spatial entities 604A-E, 604J, can be excluded from the set of spatial entities 604F-I provided to a requesting XR application. Some implementations can infer the volume of room 612 by, for example, accessing guardian data for room 612 on XR device 610, generating or accessing a room box for room 612 by scanning room 612 and placing virtual walls where physical walls are missing, etc.

FIG. 6C is a conceptual diagram illustrating an example view 600C of a real-world environment 602 having selected and unselected spatial entitles 604A-N overlaid thereon based on a distance filter being applied inside a room 614 (e.g., a delineated physical space). When room 614 has open doorways 616A-B and/or other openings in its walls, the distance filter in this example can filter available spatial entities 604A-N to those within a threshold distance of XR device 610, e.g., within a radius, r, of XR device 610. The distance filter in this example can filter available spatial entities 604A-M to include both the spatial entities 604K-M inside room 614, as well as spatial entities 604J, 604N visible through open doorways 616A-B within radius r. Thus, spatial entities outside radius r of XR device 610, e.g., unselected spatial entities 604A-I can be excluded from the set of spatial entities 604J-N provided to a requesting XR application. Although shown and described as all of spatial entities 604K-M within room 614 being within radius r of XR device 610, it is contemplated that some implementations can automatically select other spatial entities within captured room 614 (not shown), regardless of whether they are within radius r. Other implementations, however, can only select spatial entities within radius r, regardless of whether they are within room 614. In addition, it is contemplated that some implementations can identify spatial entities 604J, 604N (and potentially other spatial entities) within radius r, regardless of whether they are visible through open doorways 616A-B.

FIG. 6D is a conceptual diagram illustrating an example view 600D of a real-world environment 602 having selected and unselected spatial entities 604A-N overlaid thereon based on a distance filter being applied outside of rooms 606, 612, 614, and/or when a room surrounding XR device 610 is not captured and/or known by XR device 610. Some implementations can discover previously captured rooms 606, 614 within radius r of XR device 610 (e.g., as shown in FIGS. 6A and 6C, respectively). The distance filter in this example can filter available spatial entities 604A-N to include spatial entities 604C, 604L-N within a threshold distance of XR device 610, e.g., within radius r of XR device 610. Thus, spatial entities outside radius r of XR device 610, e.g., unselected spatial entities 604A-B, D-K, can be excluded from the set of spatial entities 604A, 604L-M provided to a requesting XR application. Although shown as including spatial entity 604C, which is within radius r, but not visible to XR device 610, it is contemplated that some implementations can exclude spatial entity 604A based on its lack of visibility to XR device 610.

FIG. 6E is a conceptual diagram illustrating an example view 600E of a real-world environment 602 having selected and unselected spatial entities 604A-J overlaid thereon based on room and distance filters being applied to a room 618 which does not have walls and/or which does not have walls captured by XR device 610. In view 600E, however, XR device 610 has captured and/or identified furniture 620A-B, e.g., as scene data in a partial room capture. Because no walls are found, some implementations can default to a maximum distance from XR device 610, and select spatial entities within radius r of XR device 610, e.g., spatial entities 604F-G, 604I. Thus, spatial entities 604A-E belonging to other rooms, e.g., room 606, can be filtered out, as well as spatial entities 604H, 604J outside of radius r of XR device 610. In some implementations, spatial entities 604A-E of room 606 can be filtered out based on a previously captured and/or established room box (e.g., including known or inferred walls) for room 606. Thus, unselected spatial entities 604A-E, 604H, 604J can be excluded from the set of spatial entities 604F-G, 604I provided to a requesting XR application.

FIG. 6F is a conceptual diagram illustrating an example view 600F of a real-world environment 602 having selected and unselected spatial entities 604A-I overlaid thereon based on room and distance filters being applied to a room 622 having walls longer than a threshold (e.g., greater than seven meters). When XR device 610 is on one side of room 622 with spatial entities across the length of room 622, some spatial entities 604A, 604D outside of a threshold distance from XR device 610 (e.g., five meters) are not discoverable and/or have low confidence (e.g., a percentage or other value indicating likelihood of accuracy of the position and/or orientation of spatial entities 604A, 604D). Thus, unselected spatial entities 604A, 604D can be excluded from the set of spatial entities 604B-C. 604E-I provided to the requesting XR application.

FIG. 7 is a conceptual diagram illustrating an example 700 real-world environment 702 having locally captured and remotely obtained spatial entities overlaid thereon. Real-world environment 702 can be a physical, real-world room in which an XR device, such as an XR HMD (not shown) can render an XR experience for a requesting XR application. The XR device can create and/or capture spatial entities 704A-C in real-world environment 702, which can include, for example, guardian 704A, spatial anchor 704 B, and scene element 704C. However, in some implementations, spatial entities 704A-C may be insufficient to render a launched XR experience, and additional spatial entities may be needed. Thus, some implementations can upload captured spatial anchors 704A-C (and/or one or more visual features in real-world environment 702) to a platform computing system on a cloud, and receive preexisting spatial entities 706A-D (e.g., spatial anchors) previously captured by the XR device (or another XR device) in real-world environment 702. Captured spatial entities 704A-C and preexisting spatial entities 706A-D can then be used as frames of reference for virtual objects to be displayed within real-world environment by 702 to render the XR experience.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for discovering multiple spatial entities, proximate to a user of an artificial reality device in a real-world environment, for rendering an artificial reality environment, the method comprising:
receiving, from an artificial reality application executing on the artificial reality device, a request to identify and return the multiple spatial entities proximate to the user;
localizing the artificial reality device to a position in the real-world environment;
identifying the multiple spatial entities proximate to the user, the multiple spatial entities proximate to the user including A) one or more spatial entities within a threshold distance of the position in the real-world environment and B) one or more spatial entities within a delineated physical space surrounding the position in the real-world environment;
ranking the identified multiple spatial entities; and
outputting spatial entity data, including the ranked multiple spatial entities, to the artificial reality application, wherein the artificial reality application causes rendering of the artificial reality environment based, at least partially, on the ranked multiple spatial entities.

2. The method of claim 1, wherein the spatial entity data further includes geometry data and semantic labels for the ranked multiple spatial entities.

3. The method of claim 1, wherein the multiple spatial entities include one or more spatial anchors established for the real-world environment, one or more scene elements established for the real-world environment, one or more three-dimensional meshes established for the real-world environment, or any combination thereof.

4. The method of claim 1, wherein the delineated physical space surrounding the position in the real-world environment is identified through computer vision techniques.

5. The method of claim 1, wherein at least one of the multiple spatial entities are private to the user or the artificial reality device.

6. The method of claim 1, wherein at least one of the multiple spatial entities are shared from another artificial reality device that accessed the real-world environment.

7. The method of claim 1, wherein the ranking of the multiple spatial entities is performed based on at least one of distance from the position in the real-world environment, relevance to the artificial reality application, relevance to the user, or any combination thereof.

8. The method of claim 1, wherein the position of the artificial reality device in the real-world environment is localized on one or more Simultaneous Localization and Mapping (SLAM) maps.

9. The method of claim 8, wherein the multiple spatial entities are identified from multiple SLAM maps, the multiple SLAM maps being obtained from the artificial reality device, from a cloud, or any combination thereof.

10. The method of claim 1, wherein the multiple spatial entities include one or more spatial entities created by the artificial reality application, one or more spatial entities created by the artificial reality device, or any combination thereof.

11. A computer-readable storage medium storing instructions that, when executed by a computing system, cause the computing system to perform a process for discovering multiple spatial entities, proximate to a user of an artificial reality device in a real-world environment, for rendering an artificial reality environment, the process comprising:
receiving, from an artificial reality application executing on the artificial reality device, a request to identify and return the multiple spatial entities proximate to the user;
localizing the artificial reality device to a position in the real-world environment;
identifying the multiple spatial entities proximate to the user, the multiple spatial entities proximate to the user including A) one or more spatial entities within a threshold distance of the position in the real-world environment, B) one or more spatial entities within a delineated physical space surrounding the position in the real-world environment, or C) any combination thereof;
ranking the identified multiple spatial entities; and
outputting spatial entity data, including one or more of the ranked multiple spatial entities, to the artificial reality application, wherein the artificial reality application causes rendering the artificial reality environment based, at least partially, on the one or more of the ranked multiple spatial entities.

12. The computer-readable storage medium of claim 11, wherein the multiple spatial entities proximate to the user include one or more spatial entities within the threshold distance of the position in the real-world environment and one or more spatial entities within the delineated physical space surrounding the position in the real-world environment.

13. The computer-readable storage medium of claim 11, wherein the spatial entity data further includes geometry data and semantic labels for the one or more of the ranked multiple spatial entities.

14. The computer-readable storage medium of claim 11, wherein the multiple spatial entities include one or more spatial anchors established for the real-world environment, one or more scene elements established for the real-world environment, one or more three-dimensional meshes established for the real-world environment, or any combination thereof.

15. The computer-readable storage medium of claim 11, wherein the delineated physical space surrounding the position in the real-world environment is identified through computer vision techniques.

16. A computing system for discovering multiple spatial entities, proximate to a user of an artificial reality device in a real-world environment, for rendering an artificial reality environment, the computing system comprising:
one or more processors; and
one or more memories storing instructions that, when executed by the one or more processors, cause the computing system to perform a process comprising:
receiving, from an artificial reality application executing on the artificial reality device, a request to identify and return the multiple spatial entities proximate to the user;
localizing the artificial reality device to a position in the real-world environment;
identifying the multiple spatial entities proximate to the user, the multiple spatial entities proximate to the user including A) one or more spatial entities within a threshold distance of the position in the real-world environment, B) one or more spatial entities within a delineated physical space surrounding the position in the real-world environment, or C) any combination thereof;
ranking the identified multiple spatial entities; and
outputting spatial entity data, including one or more of the ranked multiple spatial entities, to the artificial reality application, wherein the artificial reality application causes rendering of the artificial reality environment based, at least partially, on the one or more of the ranked multiple spatial entities.

17. The computing system of claim 16, wherein the multiple spatial entities proximate to the user include one or more spatial entities within the threshold distance of the position in the real-world environment and one or more spatial entities within the delineated physical space surrounding the position in the real-world environment.

18. The computing system of claim 16, wherein the ranking of the multiple spatial entities is performed based on at least one of distance from the position in the real-world environment, relevance to the artificial reality application, relevance to the user, or any combination thereof.

19. The computing system of claim 16, wherein the position of the artificial reality device in the real-world environment is localized on one or more Simultaneous Localization and Mapping (SLAM) maps.

20. The computing system of claim 16, wherein the multiple spatial entities include one or more spatial entities created by the artificial reality application, one or more spatial entities created by the artificial reality device, or any combination thereof.
